(19) United States
(12) Patent Application Publication
(10) Pub. No.: US 2007/0229243 A1
(43) Pub. Date: Oct. 4, 2007

(54) Bidirectional Object-proximity Dual Alarm System

(76) Inventor: Alfonzo Welch, Dallas, TX (US)

Correspondence Address: WILSON DANIEL SWAYZE, JR., 3804 CLEARWATER CT., PLANO, TX, 75025, US

(21) Appl. No.: 11/687,868

(22) Filed: Mar. 19, 2007

Related U.S. Application Data
(60) Provisional application No. 60/783,515, filed on Mar. 17, 2006.

(51) Int. Cl. B60Q 1/00

(52) U.S. Cl. 340/457

(57) ABSTRACT

The present invention includes system for preventing a child from being unattended in a child's car seat, which includes a master unit for mounting in the car seat and adapted for two-way wireless communication and a slave unit being portable and adapted for two-way communication with the master unit and having a slave alarm. The slave alarm is activated when the master unit and the slave unit are separated by a predetermined distance. The master unit includes a master switch to indicate that the child is fasten in the car seat, and the master alarm includes a LED and horn. The master unit will activate the master alarm when the master switch is closed and there is no communication with the slave unit. The master unit includes a FM receiver to receive data from the slave unit, and the master unit includes a FM transmitter to transmit data to the slave unit.

### PRIORITY

The present invention claims priority under 35 USC section 119 based on a provisional application Ser. No. 60/783,515 filed on Mar. 17, 2006.

In 1996, as a result of the increasing number of deaths of small children resulting from the supplemental restraint system of automobiles which is commonly known as an air bag, the states mandated that all children who were subject to the child safety seat could no longer be placed in the front seat. Consequently, the child safety seat and child are currently required to be placed in the rear seat of the automobile. Consequently, since these children are no longer subject to the immediate attention of the driver, it is possible for the driver to leave the automobile without removing the child from the child safety seat. Especially in warmer climates, the temperature within the car can rise to the point where the health of the child is endangered. Studies have shown that between 1996 and 2001 more than 171 children have died as a result of being unintentionally left in the automobile unattended. Furthermore, studies suggest that these numbers are increasing.

Previous car seats and child safety seat patents include child presence and position monitors and devices that monitor motion and temperature in parked automobiles as well as devices that monitor when the automobile ignition is turned off. However, none of these devices adequately or effectively address the problem as discussed above. None of these devices prevents the driver/caregiver from unintentionally leaving a child unattended in an automobile.

U.S. Pat. No. 6,714,132 discloses a system and method that uses a wireless tether comprising a transmitter and a receiver to alert a caregiver that an object or person has been left unattended. A detector senses the presence of the object, usually a child, located in a position such as a safety seat. The detector couples to the transmitter, which is located near the object. The transmitter transmits at least one wireless signal when the object is in the position. The receiver, which is remotely located from the transmitter, senses the at least one signal as long as the receiver is within a prescribed range of transmission. By performing a timing function, the receiver monitors the proximity of the caregiver, who maintains possession of the receiver, to the transmitter. The system communicates an alarm to the caregiver when the caregiver ventures outside the range of transmission without having removed the object/child from the position.

### SUMMARY

The present invention prevents a child from being accidentally/unintentionally left unattended in a parked automobile. The present invention includes a device that warns a driver/caretaker when a child has been left unattended in an automobile. The device of the present invention is portable and affordable and is adapted to be used with existing child safety seats and could be manufactured into new child safety seats and/or manufactured as part of the automobile. The present invention includes a wireless battery powered device that includes an object proximity monitoring and duel alarm system. The present invention includes a child safety seat shoulder harness clip unit which includes a stationary transceiver and alarm (master unit) and a key fob (slave unit) or other portable or stationary unit which includes a transceiver and an alarm.

The system of the present invention includes a first transceiver (master unit) which may be housed within a child safety seat shoulder harness clip assembly. As the parent/caregiver fastens the safety shoulder harness clip unit, a switch is activated to transmit to a second transceiver (slave unit) which may be part of the key fob. As the parent/caregiver unfastens the safety shoulder harness clip unit, the switch is deactivated.

The second transceiver may be housed within a portable key fob assembly. The second transceiver may acknowledge a proximity communication from the first transceiver. In addition, the second transceiver may be housed within the stationary driver seat belt adapter and is activated and deactivated based upon the driver fastening and unfastening his/her seat belt.

When the switch is activated indicating that the child is sitting in the child safety seat shoulder harness clip and the second transceiver is removed from the proximity of the first transceiver for example by moving a predetermined distance away from the first transceiver, the alarm associated with the second transceiver and the key fob unit will sound.

The present invention includes bidirectional communication between the first transceiver associated with the child safety seat shoulder harness clip and the second transceiver associated with the key fob unit. Should the driver/caregiver forget the key fob unit including the second transceiver, when the child is locked into the child safety seat shoulder harness, the alarm associated with the child safety seat shoulder harness will activate to warn the driver/caregiver that the key fob unit is not present. The alarm associated with the child safety seat shoulder harness is only extinguished when the child safety seat harness is unclipped or within the proximity of the key fob unit. These features can act as a self test of the present invention.

The present invention includes system for preventing a child from being unattended in a child's car seat, which includes a master unit for mounting in the car seat and adapted for two-way wireless communication and a slave unit being portable and adapted for two-way communication with the master unit and having a slave alarm. The slave alarm is activated when the master unit and the slave unit are separated by a predetermined distance.

The master unit includes a master switch to indicate that the child is fastened in the car seat, and the master alarm includes a LED and horn.

The master unit will activate the master alarm when the master switch is closed and there is no communication with the slave unit.

The master unit includes a FM receiver to receive data from the slave unit, and the master unit includes a FM transmitter to transmit data to the slave unit.

The slave unit includes a FM receiver to receive data from the master unit, and the slave unit includes a FM transmitter to transmit data to the master unit.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates a flow chart diagram of the master unit;

FIG. 2 illustrates a flow chart diagram of the slave unit;

FIG. 3 illustrates an exploded view of the master unit;

FIG. 4 illustrates an exploded view of the slave unit;

FIG. 5 illustrates a bottom view of the master unit;

FIG. 6 illustrates a side cross-sectional view of the master unit;

FIG. 7 illustrates a top view of the master unit;

FIG. 8 illustrates an end cross-sectional view of the master unit;

FIG. 9 illustrates a perspective top view of the master unit;

FIG. 10 illustrates a perspective bottom view of the master unit;

FIG. 11 illustrates an end cross-sectional view of the slave unit;

FIG. 12 illustrates a top perspective view of the slave unit;

FIG. 13 illustrates a top view of the slave unit;

FIG. 14 illustrates another top perspective view of the slave unit;

FIG. 15 illustrates a side cross-sectional view of the slave unit;

FIG. 16 illustrates a back view of the slave unit;

FIG. 17 illustrates a back perspective view of the slave unit;

FIG. 18 illustrates a system including the master unit and the slave unit of the present invention;

FIG. 19 illustrates a circuit diagram for both the master unit and a slave unit of the present invention;

FIG. 20 illustrates another circuit diagram for both the master unit and the slave unit of the present invention;

### DETAILED DESCRIPTION

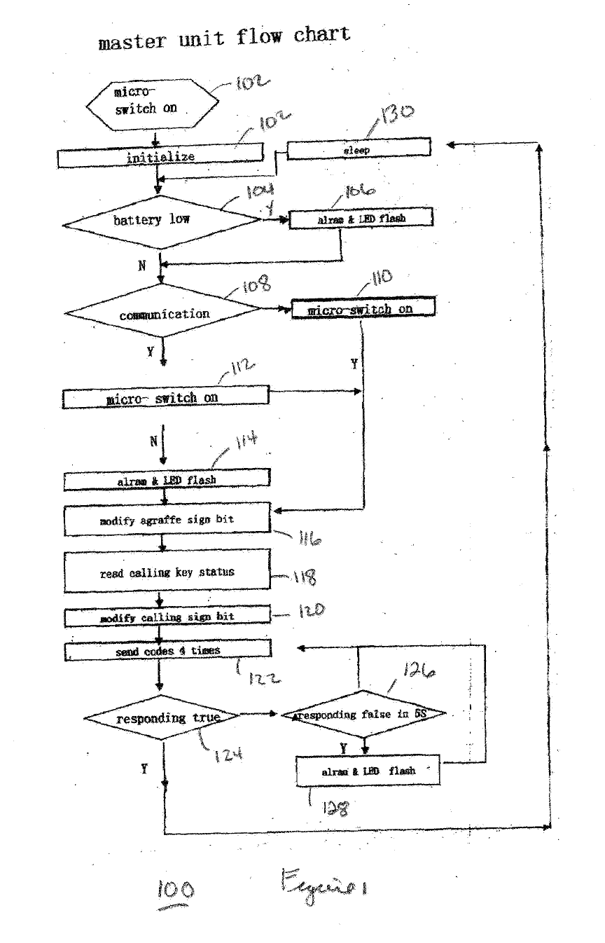

FIG. 1 illustrates the master unit flowchart which includes turning on a microswitch on in its step 102 which activates the master unit. Next control is received by an initialized step 102 which initializes the necessary program values, then control passes to the battery low step 104 which compares the battery voltage with a predetermined battery voltage to determine if the battery level is low. If the results of the comparison is that the battery level is lower than the predetermined battery voltage than the alarm and LED flash step 106 is executed to flash a warning and to activate an audible alarm indicating that the battery is insufficiently low. If the battery level is higher than the predetermined battery voltage and the communication step 108 is executed. Additionally, after the alarm and LED flash step 106 the communication step 108 is executed. The communication step 108 attempts to communicate with the slave unit. If the communication step 108 cannot communicate with the slave unit, for example the slave unit may be turned off or too far away by being more than a predetermined distance from the master unit, then the microswitch on step 110 is executed. The micro switch on step 112 determines if the microswitch of the child seat has been turned on. If the microswitch of the child seat has been turned on, then control passes to step 116. If the microswitch on step 112 determines that the microswitch of the child seat has not been turned on, then control passes to the alarm and LED flash step 114 to indicate that the microswitch is not on.

In step 116, the agraffe sign bit is modified, and the read calling key status step 118 is executed. In the modify calling sign bit step 118, the calling sign bit is modified. In the send code 4 times step 112, the code is sent four times to the slave unit, and in the responding true step 124, the master unit determines if the slave unit is authorized by the response from the slave unit. If the slave unit is authorized, then the master unit goes to step 130 where the master unit goes asleep until the further action is required. If the response is not true then step 124 transfers control to the step 126. In step 126, the responding false in five second step waits five seconds for a true response, if the response is false in step 122 after five seconds, then the alarm and LED flash step 128 is executed to alert the user that the slave unit cannot be reached and control is passed to step 122.

FIG. 2 illustrates the logic diagram for the slave unit which includes the second transceiver. In step 202, the calling key for the slave unit is pressed, and in step 204, the slave unit is initialized. In step 206, the battery is tested to determine if the battery is low as measured by a predetermined voltage, and if the battery is low, the alarm and LED associated with the slave unit are activated to indicate the low battery condition in step 210. If the battery is not low then step 212 is executed. In step 212, the slave unit is attempting to communicate with the master unit, and in step 214, the slave unit reads the key status. In step 216, the slave unit modifies the sign bit. Step 218 determines if the slave unit has received a signal from the master unit, and in step 220, an alarm and LED flash is activated on the slave unit if there is no communication with the master unit. If the slave unit has received the signal from the master unit, then in step 222, a feedback signal is sent to the master unit to indicate that the slave unit has received the signal from the master unit. In step 226, a suggestive sound and LED flash is activated, and control passes to step 224 to end the alarm, and control is passed to step 218. Control passes to step 208 where the slave unit enters a sleep mode. In step 228, it is determined if the study key switch is on, and if the study key switch is on, the buzzer is played two times in step 230. In step 232, the slave unit receives a signal from the master unit, and in step 234 the slave unit saves the slave ID to EEPROM. In step 236, a suggestive sound and LED flash is activated. The slave unit can memorize the frequencies of the master unit.

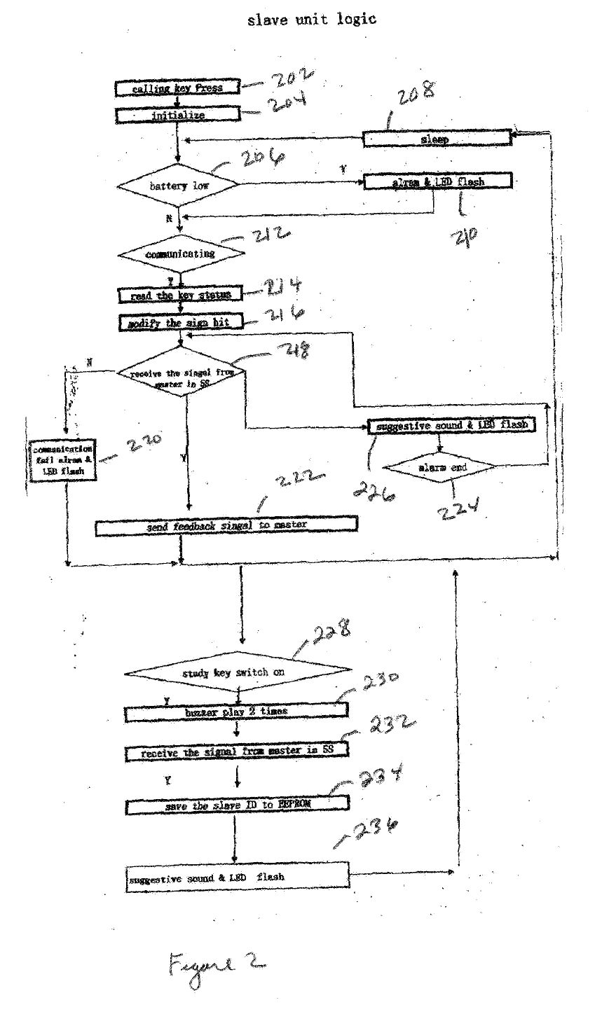

FIG. 3 illustrates an exploded view of the master unit 300 of the present invention. The master unit 300 includes a first housing section 302 and a second housing section 304 for the top of the master unit 300, and the master unit 300 includes a third housing section 310 and a fourth housing section 312 for the bottom of the master unit 300. FIG. 3 additionally illustrates a switch 306 which may be a micro switch which when closed indicates that the child is positioned within the child safety shoulder harness clip assembly and a PCB board member 308 for mounting the electronic circuits associated with the master unit 300. FIG. 3 additionally illustrates the battery 314 for providing power for the electronic circuits and the LED 316.

FIG. 4 illustrates the slave unit 400 of the present invention. The slave unit 400 includes a first housing section 402 and a second housing section 404 for the bottom of the slave unit 400. FIG. 4 additionally illustrates the third housing section 406 for the top of the slave unit 400. FIG. 4 additionally illustrates that the slave unit 400 includes an antenna 408 for communication with the master unit 300 and a switch 410 for turning on and off the slave unit 400.

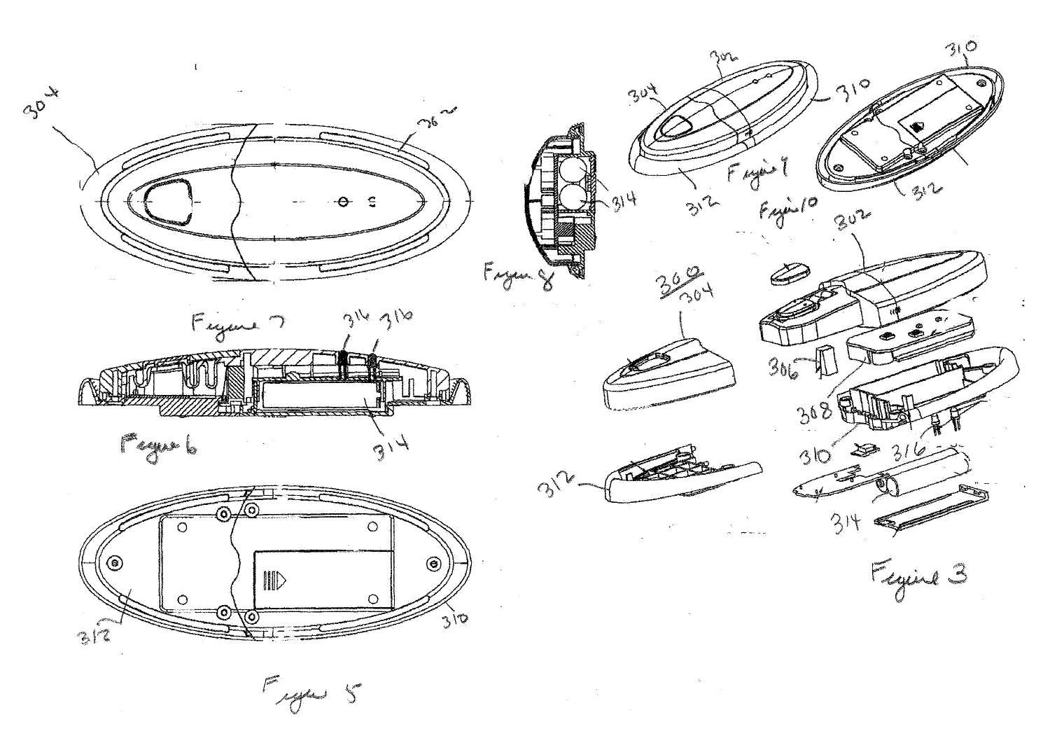

FIG. 5 illustrates the third housing section 310 and the fourth housing section 312 of the bottom of the master unit 300 FIG. 6 illustrates a cross section of the master unit 300 and illustrates the battery 314 and LED 316 of the present invention.

FIG. 7 illustrates the first housing section 302 and a second housing section 304 of the present invention.

FIG. 8 illustrates a cross section of the side of the master unit 300 showing the batteries 314.

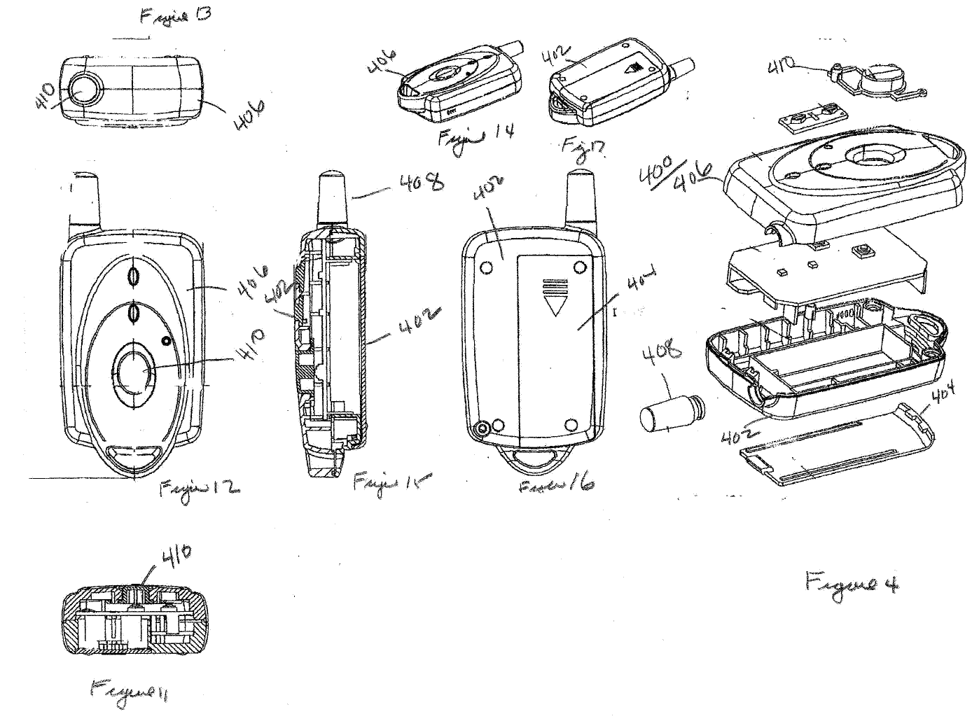

FIG. 9 illustrates a perspective view of the top of the master unit 300 showing the first housing section 302 and the second housing section 304.

FIG. 10 illustrates a perspective view of the bottom of the master unit 300 showing the third housing section 310 and the fourth housing section 312.

FIG. 11 illustrates a cross-sectional view of an end of the slave unit 400 which shows the switch 410.

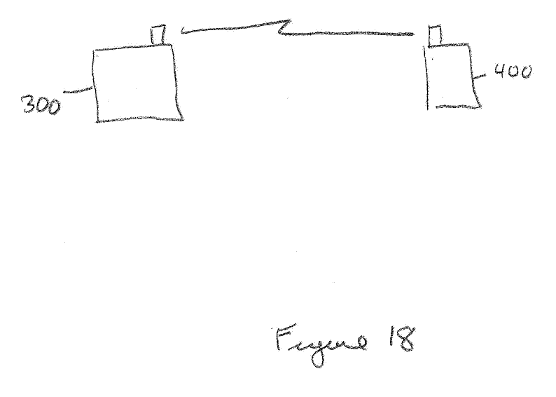

FIG. 12 illustrates the third housing section 406 and the switch 410.

FIG. 13 illustrates another view of the third housing section 406 and the switch 410.

FIG. 14 illustrates a top perspective view of the third housing section 406.

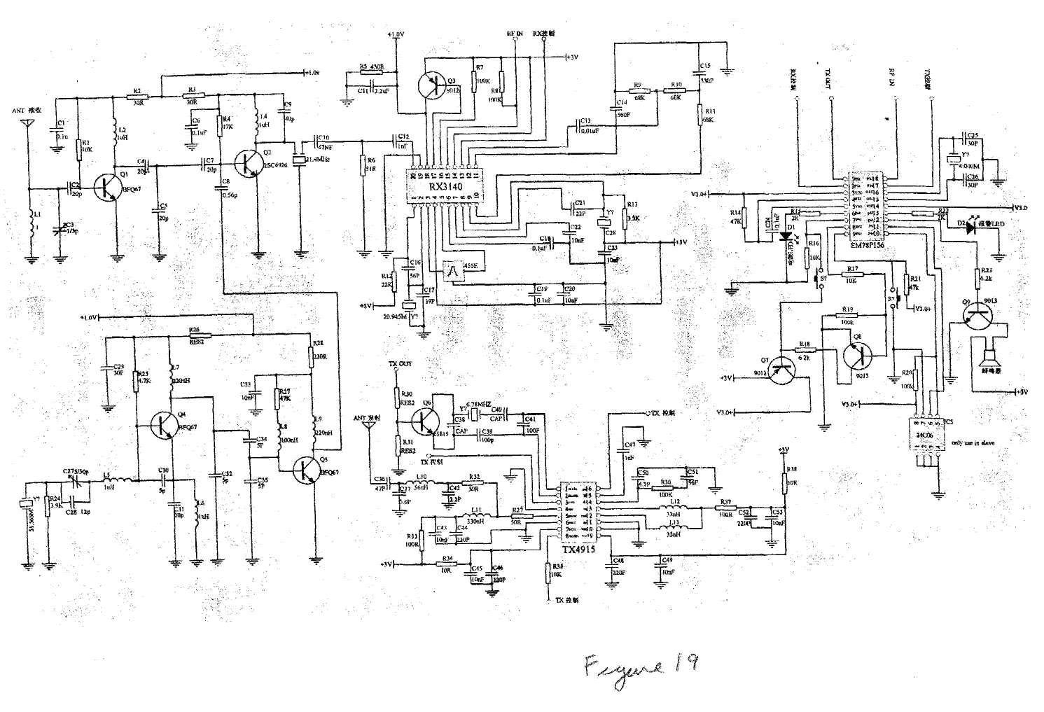

FIG. 15 illustrates a cross-sectional side view showing the first housing section 402 and the third housing section 406. FIG. 15 additionally illustrates the antenna 408.

FIG. 16 illustrates a back view of the slave unit 400 including the first housing section 402 and the second housing section 404.

FIG. 17 illustrates a back perspective view of the slave unit 400 including the first housing section 402.

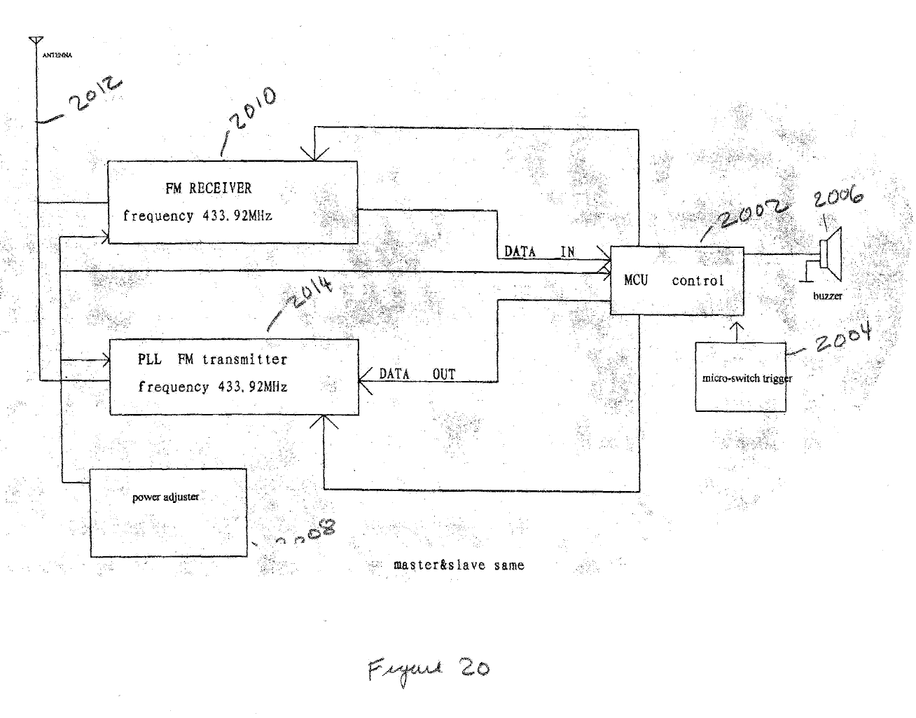

FIG. 18 illustrates a system view of the master unit 300 in communication with the slave unit 400.

FIG. 19 illustrates an electrical circuit for both the master unit 300 and the slave 400.

FIG. 20 illustrates a block diagram of the electrical circuit for both the master unit 300 and the slave unit 400. The block diagram includes a micro control unit (MCU) 2002 for control of the electrical circuit. The micro control unit 2002 accepts input of the micro switch trigger 2004 and is connected to the buzzer 2006. Data is input to the microcontroller unit 200 from the power adjuster 2008 and from the FM receiver 2010 which receives wireless signals from either the master unit 300 or the slave unit 400 and which is connected to the antenna 2012. The micro controller unit 2002 outputs data to the phase lock loop (PLL) FM transmitter 2014 which transmits the data on the antenna 2012 to be received by either the master unit 300 or the slave unit 400. The master unit 300 would include the circuits shown in FIGS. 19 and 20, and the slave unit 400 would include the circuits shown in FIGS. 19 and 20.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1) A system for preventing a child from being unattended in a child's car seat, comprising:
a master unit for mounting in the car seat and adapted for two-way wireless communication;
a slave unit being portable and adapted for two-way communication with the master unit and having a slave alarm;
wherein the slave alarm is activated when the master unit and the slave unit are separated by a predetermined distance.

2) A system for preventing a child from being unattended in a child's car seat as in claim 1, wherein the master unit includes a master switch to indicate that the child is in the car seat.

3) A system for preventing a child from being unattended in a child's car seat as in claim 1, wherein the master alarm includes a LED and horn.

4) A system for preventing a child from being unattended in a child's car seat as in claim 2, wherein the master unit will activate the master alarm when the master switch is closed and there is no communication with the slave unit.

5) A system for preventing a child from being unattended in a child's car seat as in claim 1, wherein the master unit includes a FM receiver to receive data from the slave unit.

6) A system for preventing a child from being unattended in a child's car seat as in claim 1, wherein the master unit includes a FM transmitter to transmit data to the slave unit.

7) A system for preventing a child from being unattended in a child's car seat as in claim 1, wherein the slave unit includes a FM receiver to receive data from the master unit.

8) A system for preventing a child from being unattended in a child's car seat as in claim 1, wherein the slave unit includes a FM transmitter to transmit data to the master unit.
